(19) United States
(12) Patent Application Publication
(10) Pub. No.: US 2020/0013043 A1
(43) Pub. Date: Jan. 9, 2020

(54) CONTACTLESS INTERACTION SYSTEM, APPARATUS AND METHOD

(71) Applicant: MASTERCARD INTERNATIONAL INCORPORATED, Purchase, NY (US)

(72) Inventors: Patrik Smets, Nijlen (BE); Patrick Mestre, Sart-bernard (BE); Eddy Van De Velde, Leuven (BE)

(21) Appl. No.: 16/486,393

(22) PCT Filed: Feb. 21, 2018
(86) PCT No.: PCT/US2018/018873

§ 371 Date: Aug. 15, 2019

(30) Foreign Application Priority Data
Feb. 21, 2017 (GB) 1702795.4

(51) Int. Cl. G06Q 20/32; G06Q 20/40

(52) U.S. Cl. CPC G06Q 20/3278; G06Q 20/405; G06Q 20/40145

(57) ABSTRACT

A method of operating a transaction device to perform a contactless transaction with a terminal 3 of a transaction system is described. The method comprises the following steps: determining if the transaction device has associated with it a mechanism for providing user verification at the device, and if there is an associated user verification mechanism, transacting with the terminal 3 according to a first transaction protocol, and if there is no associated user verification mechanism, transacting with the terminal 3 according to a second transaction protocol. This approach is particularly suitable for use with transaction devices implemented as wearable devices 1. A suitable wearable device 1 and software for programming such a wearable device are also described.

### CROSS-REFERENCE TO RELATED APPLICATION

This application claims the benefit of, and priority to, European Patent Application No. 1702795.4 filed on Feb. 21, 2017. The entire disclosure of the above application is incorporated herein by reference.

### FIELD OF DISCLOSURE

The present disclosure relates to a contactless interaction system, apparatus and method. It is particularly relevant to wearable devices adapted for contactless interaction, for example payment according to a contactless transaction protocol.

### BACKGROUND OF DISCLOSURE

It is increasingly common for wearable devices to be used to provide functionality to users both through processing capability in the wearable device and by interaction with other digital devices. While some wearable devices have an extended networking capability (using cellular telephony or 802.11 based wireless networking protocols such as WiFi), others are adapted only for short range interaction using Bluetooth or Near Field Communication protocols. Wearable devices typically have specific actions that are extremely convenient for users, but have a limited user interface and often relatively limited processing power. This can be addressed in some cases by pairing with another device—for example, so that significant computation and a user interface is provided by a user cellular telephone handset paired to a wearable device using Bluetooth—but this creates other challenges.

Providing a wearable device that is adapted for use as a transaction device poses particular challenges. Protocols and applications exist for treating a cellular telephone handset as a transaction device adapted to transact with a terminal of a financial transaction system (such as a POS terminal) using contactless protocols. Typically contactless protocols allow payments for small value transactions to be made without additional cardholder verification, but larger payments, if allowed, require cardholder verification. This poses processing and security challenges for a wearable device with a limited user interface.

### SUMMARY OF DISCLOSURE

In a first aspect, the disclosure provides a method of operating a transaction device to perform a contactless transaction with a terminal of a transaction system, the method comprising: determining if the transaction device has associated with it a mechanism for providing user verification at the device, and if there is an associated user verification mechanism, transacting with the terminal according to a first transaction protocol, and if there is no associated user verification mechanism, transacting with the terminal according to a second transaction protocol.

The contactless transaction may be performed under the ISO/IEC 14443 standard, and may use EMV contactless protocols (EMV specifications may be found at https://www.emvco.com/document-search/)—the user is represented by a transaction application running on the wearable device. The user verification mechanism may be a Consumer Device Cardholder Verification Method (CDCVM), and may be provided at the wearable device itself, or may be provided through a device such as the user's cell phone—it may for example be a biometric identifier of the user, such as a fingerprint. The transaction is performed by an application in the wearable device, but the user verification mechanism may be mediated through a further application in the wearable device interacting with the transaction application.

Where CDCVM or a similar mechanism exists, the transaction application may transact in a similar manner to a mobile phone running a mobile transaction application—CDCVM is used to provide confirmation that the deviceholder is the legitimate cardholder. For mobile phone applications, CDCVM is typically the only form of Customer Verification Method (CVM) supported. Where CDCVM does not exist (for example, if the user has the wearable device but not the associated device capable of providing CDCVM), the transaction application uses a different protocol and transacts as a contactless card. When transacting as a card, CDCVM is not normally an available option and other CVM mechanisms (such as entry of a PIN) need to be used—the transaction application may be configured to provide basic contactless card functionality. This approach allows flexibility in use of the wearable device while retaining the ability to operate with a limited set of software in the wearable device, reducing computational complexity, power demand and cost. This allows desirable form factors (such as a ring, or a band, a strap or a pendant) to be available for use.

Configuration of user verification mechanism may be performed by the issuer before user personalisation, or may occur at a user personalisation step.

In a second aspect, the disclosure provides a wearable device, or a system comprising a wearable device and an associated user device, adapted to carry out a method as set out above.

In a third aspect, the disclosure provides software which when installed on a suitable wearable device, or system comprising a wearable device and an associated user device, performs a method as set out above.

In further aspects, the disclosure provides further novel combinations of functionality in enabling wearable devices to provide contactless transaction capabilities, both when provided with user verification mechanisms and when not so provided.

### BRIEF DESCRIPTION OF THE DRAWINGS

One or more embodiments of the disclosure will now be described, by way of example only, with reference to the accompanying drawings, in which:

FIG. 1 is a schematic diagram illustrating a typical four-party model used in payment interactions between entities operating in a card scheme;

FIG. 2 is a schematic diagram illustrating elements of a transaction system implementation adapted to use embodiments of the disclosure;

FIGS. 3A, 3B and 3C illustrate computing architectures used for specific embodiments using the transaction system implementation of FIG. 2;

FIGS. 4A and 4B show exemplary wearable devices with customer verification available at the device and not available at the device respectively;

FIGS. 5A to 5C show implementations of a GET PROCESSING OPTIONS command according to an embodiment of the disclosure;

FIGS. 6A to 6J show implementations of a GENERATE AC command according to an embodiment of the disclosure; and

FIGS. 7A to 7G show implementations of a COMPUTE CRYPTOGRAPHIC CHECKSUM command according to an embodiment of the disclosure.

### DESCRIPTION OF SPECIFIC EMBODIMENTS

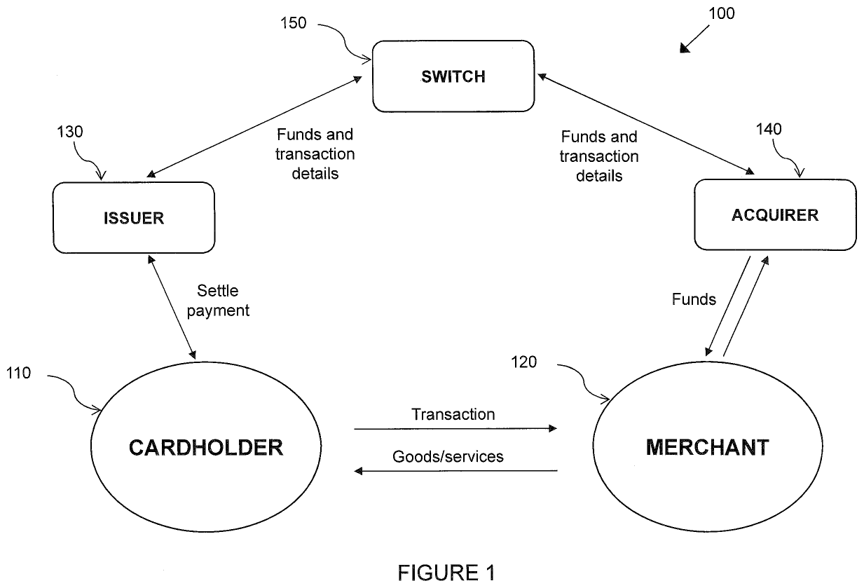

Specific embodiments of the disclosure will be described below. Embodiments of the disclosure are particularly relevant to a four-party payment transaction scheme, though embodiments of the disclosure may also be provided for other payment models and payment transaction schemes. For convenience, a typical four-party model or four-party payment transaction scheme will first be described with reference to FIG. 1. The diagram illustrates the entities present in the model and the interactions occurring between entities.

Normally, card schemes—payment networks linked to payment cards—are based on one of two models: a three-party model (adopted by American Express) or a four-party model (adopted by Visa and Mastercard). For the purposes of this document, the four-party model 100 is described in further detail below.

The four-party model may be used as a basis for the transaction network. For each transaction, the model comprises four entity types: cardholder 110, merchant 120, issuer 130 and acquirer 140. In this model, the cardholder 110 purchases goods or services from the merchant 120. The issuer 130 is the bank or any other financial institution that issued the card to the cardholder 110. The acquirer 140 provides services for card processing to the merchant 120.

The model also comprises a central switch 150—interactions between the issuer 130 and the acquirer 140 are routed via the switch 150. The switch 150 enables a merchant 120 associated with one particular bank (acquirer 140) to accept payment transactions from a cardholder 110 associated with a different bank (issuer 130).

A typical transaction between the entities in the four-party model can be divided into two main stages: authorisation and settlement. The cardholder 110 initiates a purchase of a good or service from the merchant 120 using their card. Details of the card and the transaction are sent to the issuer 130 via the acquirer 140 and the switch 150 to authorise the transaction. Should the transaction be considered abnormal by the issuer 130, the cardholder 110 may be required to undergo a verification process to verify their identity and the details of the transaction. Once the verification process is complete the transaction is authorised.

On completion of the transaction between the cardholder 110 and the merchant 120, the transaction details are submitted by the merchant 120 to the acquirer 140 for settlement.

The transaction details are then routed to the relevant issuer 130 by the acquirer 140 via the switch 150. Upon receipt of these transaction details, the issuer 130 provides the settlement funds to the switch 150, which in turn forwards these funds to the merchant 120 via the acquirer 140.

Separately, the issuer 130 and the cardholder 110 settle the payment amount between them. In return, a service fee is paid to the acquirer 140 by the merchant 120 for each transaction, and an interchange fee is paid to the issuer 130 by the acquirer 140 in return for the settlement of funds.

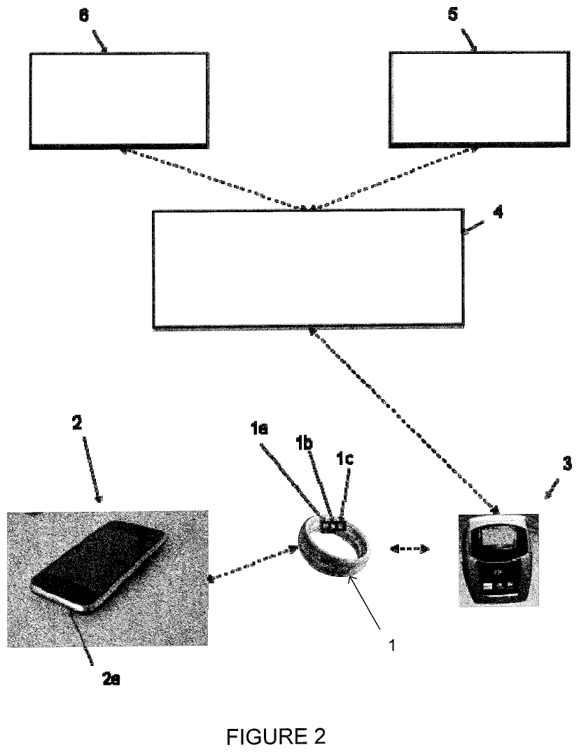

The disclosure provides a technical specification for an application for use in a wearable device 1 (here with its own processor 1a, memory 1b and power source 1c—in other embodiments the wearable device may be inductively powered) to enable the wearable device to act as a payment device in a transaction scheme. This is as illustrated in FIG. 2. The wearable device 1 may or may not be in communication with another user device such as cellular phone handset 2, which in this case has a biometric interface 2a that may be used to provide a biometric identifier for the user that can be used as CDCVM (Consumer Device Cardholder Verification Method) for the user. The wearable device 1 is adapted to perform a contactless transaction using EMV protocols with a terminal 3 of an EMV compliant transaction system. The terminal 3 connects to a transaction infrastructure 4 providing connections to an acquirer 5 acquiring the transaction for a merchant associated with the terminal 3 and an issuer 6 providing an account for the user of the wearable device 1 and the cellular phone 2. The transaction infrastructure 4 shown here encompasses the switch 150 of FIG. 1, but also includes a wider transaction environment including in this case connection pathways from the terminal 3 to the acquirer 5 and from the cellular phone 2 to the issuer 6.

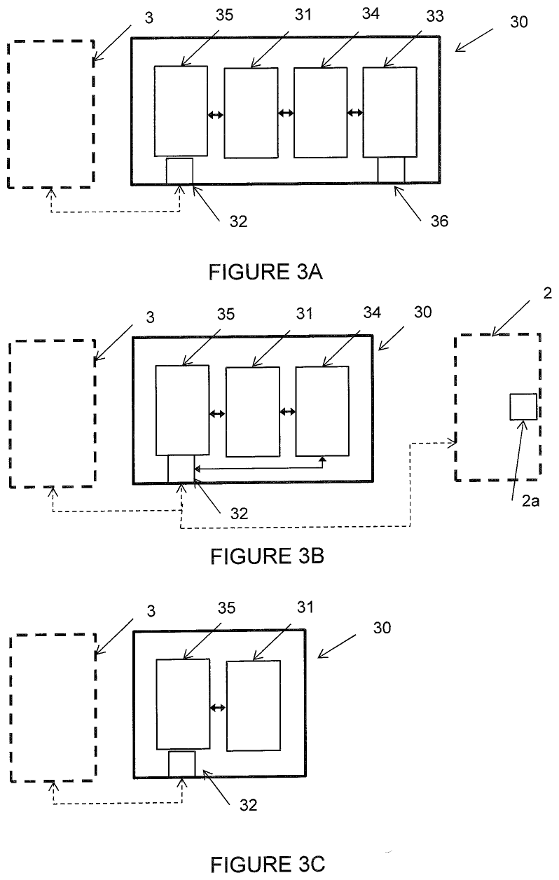

FIGS. 3A and 3B illustrate computing architectures that may be used in the arrangement of FIG. 2. In the computing architecture of FIG. 3A, there is a means for providing a CDCVM at the wearable device itself, whereas in the computing architecture of FIG. 3B, there is no such mechanism at the wearable device, but a CDCVM can be provided at another user computing device and a CDCVM result returned to the wearable device if the user computing device and the wearable device are in communication.

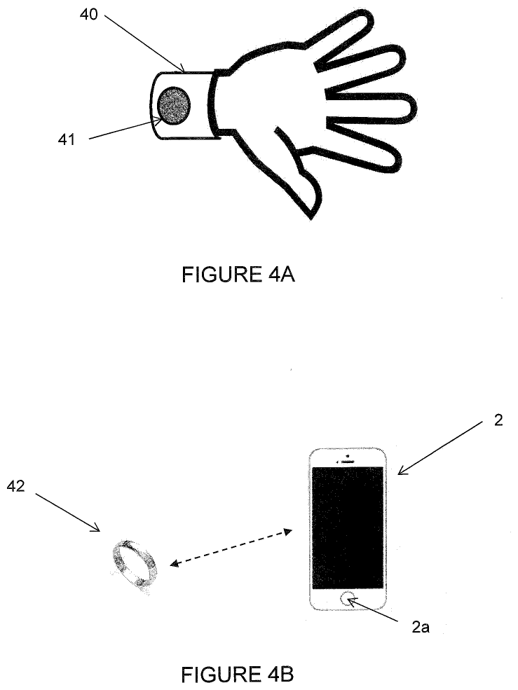

FIG. 3A shows a computing environment 30 defined by the processor 1a and the memory 1b of the wearable device. The computing environment 30 runs a wearables application 31 adapted to make contactless payments using EMV protocols. The wearables application 31 communicates with other computing environments (such as terminal 3) using a short range communications technology 32 (RFID or NFC for example) to enable it to make a contactless interaction with a terminal 3 using a Proximity Payment System Environment (PPSE) 35 in accordance with EMV standards (and hence not described here further). In this case, the wearable device 1 is adapted to support CDCVM and the computing environment thus also contains a CDCVM application 34 that interacts with the wearables application 31. In this case, the wearable device itself has a mechanism for providing a verification input at the wearable device 1—this may be, for example, a biometric sensor 36 (not shown in the FIG. 2 embodiment, though an example is shown in FIG. 4A below) such as a fingerprint sensor. This interacts with a biometric application 33—the biometric application 33 is then used by the CDCVM application to obtain a CDCVM result.

FIG. 3B shows a similar computing environment 30, but in this case there is no CDCVM mechanism at the wearable device itself In this arrangement, if CDCVM is needed it can be provided through the user's cellular phone 2 using its biometric interface 2a. The CDCVM application 34 that uses the short range communications technology 32 to interact with the user's cellular phone 2 to obtain a CDCVM result, as will be discussed further below—this may be by interaction with a partner CDCVM application on the cellular phone. In this way, a CDCVM result can be provided if necessary (and if the user's cellular phone 2 is available). In many situations, such as for low value payments, it may be sufficient to use the wearable device 1 for payment without using CDCVM—this will also be discussed further below.

A third approach is shown in FIG. 3C—in this case, the wearable device 1 is not adapted for CDCVM. In this case, the wearable device 1 is only usable where payment can be made without CDCVM.

In the embodiment discussed below, the wearables application 31 is implemented as a state machine that connects to a signalling interface for the wearables device (using a short range communications technology as described), with the wearables application implementing a form of EMV contactless specification. Discussion of this state machine is provided further below, with a description of how particular EMV features are implemented in this embodiment of the wearables application 31. Before this, provision of CDCVM and personalisation of a wearable device to a user are also discussed.

The wearables application 31 is adapted to perform contactless transactions under the ISO/IEC 14443 standard, specifically by implementing EMV contactless protocols as set out in EMV specifications as may be found at https://www.emvco.com/document-search/. The EMV contactless specifications comprise four books (Books A, B, C and D), three of which are in common between different implementations, with Book C (the kernel specification) varying according to different card schemes—the Kernel 2 approach (Mastercard) is used in implementations described here, but other kernels may be adapted similarly using the principles indicated in this document. It should be noted that this kernel supports two transaction modes: EMV Mode and Mag-Stripe Mode. The person skilled in the art will be familiar with existing EMV protocols, and will refer to these reference materials in developing any implementation of an EMV contactless specification. Existing contactless specifications will therefore not be described in detail in this document, which will concentrate on how existing routines may be developed in implementations of the present disclosure. The skilled person may therefore refer to such specifications in any assessment of the detailed teaching provided below. Abbreviations used in this document are consistent with existing EMV nomenclature, but for convenience are provided in a table at the end of this description.

In general terms, the wearables application 31 is adapted to interact with a terminal on selection through a C-APDU command received from the terminal to perform a contactless transaction. If the terminal is able to interact with the wearables application, the C-APDU will include an application identifier (AID), or an alternate AID, that matches the wearables application. The wearables application 31 is responsive to C-APDU signals (a select signal, and subsequent card commands), an unselect signal, and no other signals.

As shown in FIGS. 3A and 3B, if CDCVM is supported, then there is a CDCVM application 34 in the wearables device computing environment 30. The wearables application 31 communicates with the CDCVM application 34 as follows:
1. The wearables application 31 has access to a data maintained by the CDCVM application 34: CDCVMVerified. CDCVMVerified has value True if and only if CDCVM is currently verified for the CDCVM application.
2. The wearables application 31 has access to a data maintained by the

CDCVM application: CDCVMSubmitted. CDCVMSubmitted has value True if and only if CDCVM has been submitted to the CDCVM application for verification.
3. The wearables application 31 can inform the CDCVM application 34 that a reset of the CDCVM verification status is proposed. It is up to the CDCVM application 34 to reset the status or not when receiving the proposal.

In this way, the wearables application 31 is essentially separated in functionality from the CDCVM application 34—it is necessary for the wearables application 31 to be able to trust the results provided by the CDCVM application, so these need to be obtained and communicated in a trusted manner, typically using appropriate cryptographic means to ensure that functionality and communication paths can be trusted.

If CDCVM is obtained at the wearable device itself—as in the arrangement shown in FIG. 4A, where the wearable device is a band 40 with a fingerprint sensor 41—then the CDCVM application 34 communicates with the biometric application 33 interacting with the fingerprint sensor, and maintains CDCVMVerified if true if a qualifying successful biometric result has been received from the biometric application 33 (for example, if this has been received within a particular time of the transaction). CDCVMSubmitted is maintained on the basis of the interaction history between the CDCVM application 34 and the wearables application 31.

In other embodiments, CDCVM may be obtained at the user's cellphone, as in the arrangement shown in FIG. 4B, where a wearable ring 42 interacts with the user's cellphone 2, which has a fingerprint sensor 2a. In this case, the CDCVM application 34 interacts over the short range communications network—by a protocol such as Bluetooth, for example—with an application in the cellphone computing environment, such as a cellphone CDCVM application. The cellphone CDCVM application interacts with a biometric application in the cellphone computing environment (which itself interacts with the fingerprint sensor 2a) in a similar way, and either a CDCVMVerified result or information to allow the CDCVM application 34 to obtain a CDCVMVerified result is communicated to the CDCVM application 34 so that it can interact with the wearables application 31 as indicated above.

The determination as to whether or not the wearables device 1 supports CDCVM in embodiments described here is made before personalisation of the device to the user. Before use, the wearables device 1 and the wearables application 31 needs to be personalised to the user, along with the CDCVM application 34 and any associated biometric application 33. The biometric application 33 needs to obtain the user's reference biometric information in a trusted manner, the CDCVM application needs to establish that the specific CDCVM method (such as user fingerprint) is the specific CDCVM mechanism for that device, and the wearables application 31 needs to be personalised with card details for that user. Such personalisation processes need to be trusted both by the user and a card issuer, but are not described further here as personalisation of a payment device to a user is a standard EMV process that will be familiar to the person skilled in the art.

The state machine defining the wearables application 31 will now be described in greater detail. When the application has been personalised and is in its operational phase, its behavior can be specified as an Extended Finite State Machine. The application states are listed in Table 1 below.

TABLE 1
Application states of wearables application

| State | Description |
|---|---|
| idle | Application is not currently selected |
| selected | Application is selected and enabled |
| initiated | Transaction is initiated |

The application is in state idle if it is not currently activated. This may apply if the wearables application is a more complex device that can access more than one application. In a multi-application card for instance, the application may be in state idle if another application is activated. The application also goes to the state idle when the card is reset or powered off (unselect signal).

In the state idle the application does not process C-APDUs that are card commands from a terminal, but simply waits for an external select(C-APDU) signal. Successful processing of the select(C-APDU) signal changes the application state from idle to selected.

Every transaction starts in the state selected. There are three C-APDUs processed in this state:
GET DATA
GET PROCESSING OPTIONS
READ RECORD

The wearables application goes to state initiated after the successful processing of the GET PROCESSING OPTIONS command. The other commands do not modify the application state. Aspects of GET PROCESSING OPTIONS specific to embodiments of the disclosure are described below—neither GET DATA nor READ RECORD raises special issues that will not be apparent to a person skilled in the art, and these are not described further below.

In the state initiated, a new transaction can be initiated. There are six C-APDUs processed in this state:
COMPUTE CRYPTOGRAPHIC CHECKSUM
EXCHANGE RELAY RESISTANCE DATA
GENERATE AC
GET DATA
GET PROCESSING OPTIONS
READ RECORD

EXCHANGE RELAY RESISTANCE DATA is an existing extension to this EMV kernel that uses a challenge-response mechanism between the terminal and the payment device (in this case, the wearable device) in which the terminal measures response time to determine that the device takes to reply to a command. The number used by the terminal in the challenge may be used as the Unpredictable Number (UN) in protocols described below. Again, this functions essentially as in the existing EMV kernel, so is not described further below.

GENERATE AC is an EMV kernel command, under which the payment device generates an application cryptogram for use in payment in EMV Mode contactless transactions. Specific features of the GENERATE AC command in implementations of the disclosure are described below. The wearables application goes back from the state initiated to the state selected after successful processing of the GENERATE AC command, completed with an ARQC or AAC.

COMPUTE CRYPTOGRAPHIC CHECKSUM is an EMV kernel command, under which the payment device generates an application cryptogram for use in payment in Mag-Stripe Mode contactless transactions. Specific features of the

COMPUTE CRYPTOGRAPHIC CHECKSUM command in implementations of the disclosure are described below. The wearables application goes back from the state initiated to the state selected after successful processing of the COMPUTE CRYPTOGRAPHIC CHECKSUM command.

The other commands do not modify the application state. The signals that the wearables application accepts are thus determined by its state. When the wearables application is in the state idle, the only signal accepted from the card manager is the select(C-APDU) signal. When the wearables application is active (i.e. the application is in a state other than idle), it will accept the following signals:
The select(C-APDU) signal
The card command(C-APDU) signal
The unselect(C-APDU) signal

When receiving a select(C-APDU) signal, the wearables application may perform a validity check, and not perform any action if the validity check fails.

Individual applications (C-APDU) modified for or otherwise specific to the wearables application will now be described. Where other modifications are necessary for consistency or obvious compliance with EMV standards and requirements, these may not be expressly described as they will be apparent to the person skilled in the art.

Processing of a card command is done in three consecutive steps:
1. Analyze the C-APDU header to recognize the C-APDU (C-APDU recognition),
2. If the C-APDU is supported, check the state to decide if the C-APDU has to be processed or not (C-APDU acceptance)
3. Process the C-APDU (C-APDU processing)

When a C-APDU is recognized, the wearables application checks whether it is in a state allowing the actual processing of the C-APDU. Acceptance or rejection of a C-APDU is specified in Table 2 below. If the C-APDU is accepted in the current application state (P: Processed), then the C-APDU is processed as specified below.

TABLE 2
Processable C-APDU commands

| | state | |
|---|---|---|
| C-APDU | selected | initiated |
| COMPUTE CRYPTOGRAPHIC CHECKSUM | R/CNS | P |
| EXCHANGE REPAY RESISTANCE DATA | R/CNS | P |
| GENERATE AC | R/CNS | P |
| GET DATA | P | P |
| GET PROCESSING OPTIONS | P | P |
| READ RECORD | P | P |

### Get Processing Options

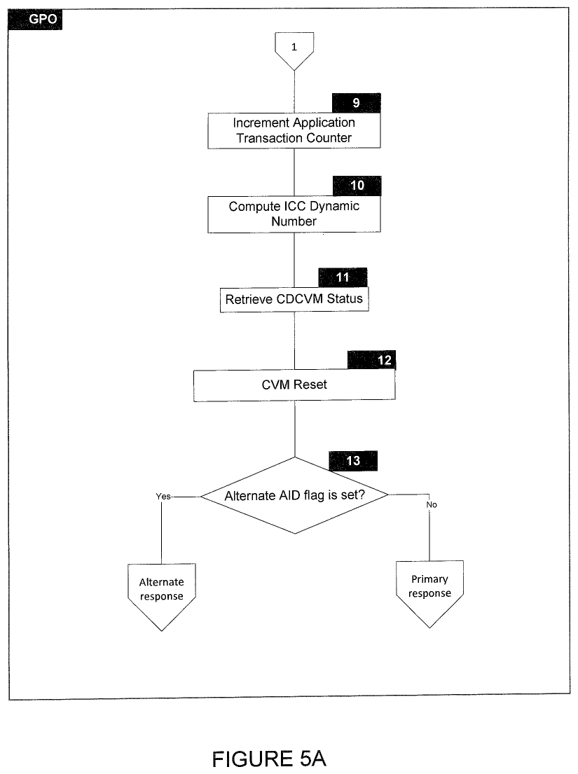

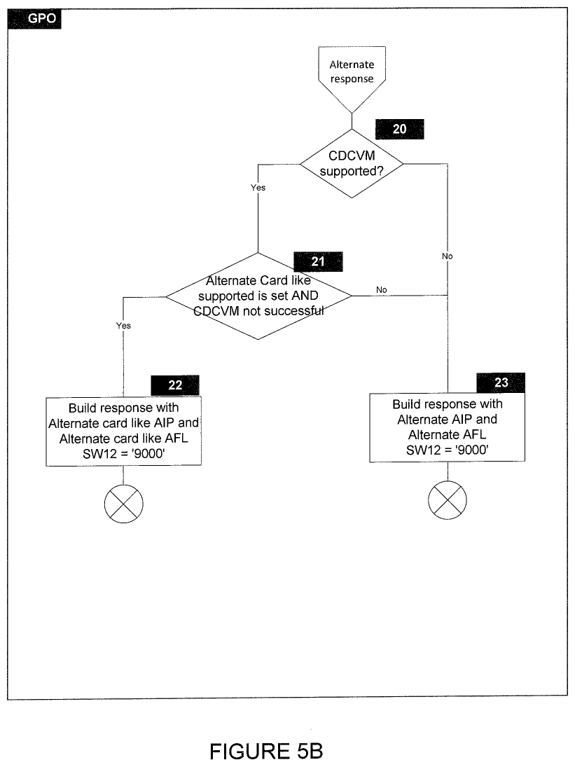

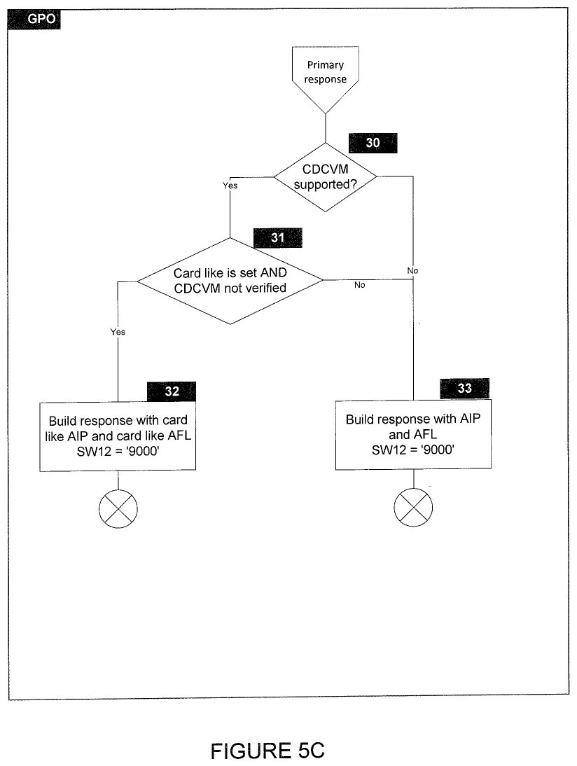

This is broadly similar to the existing EMV kernel command, but it is modified to address the different approaches that may be taken to CVM. Initial set up is conventional (and not shown,), with preparation for the new transaction shown in FIG. 5A. Incrementing of the ATC and computation of the ICC Dynamic Number are part of the existing kernel, but here the CDCVM status (CDCVMVerified and CDCVM submitted) is retrieved from the CDCVM application, if present, and a reset of the CDCVM status is proposed. There is then a check to see whether an alternate or primary AID is used. These are shown in FIGS. 5B and 5C respectively. In both cases, it is determined whether or not CDCVM is supported, and if supported but not successful, then a “card like” mode may be used. In this case, where CDCVM would otherwise be required but is not available, the transaction will not automatically fail but reversion to an alternative CVM may be possible (as for a conventional EMV contact card).

### Generate AC

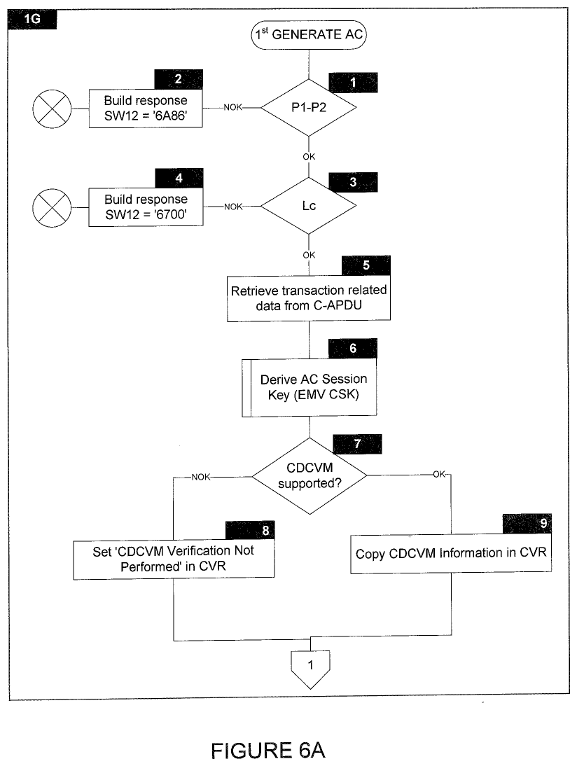

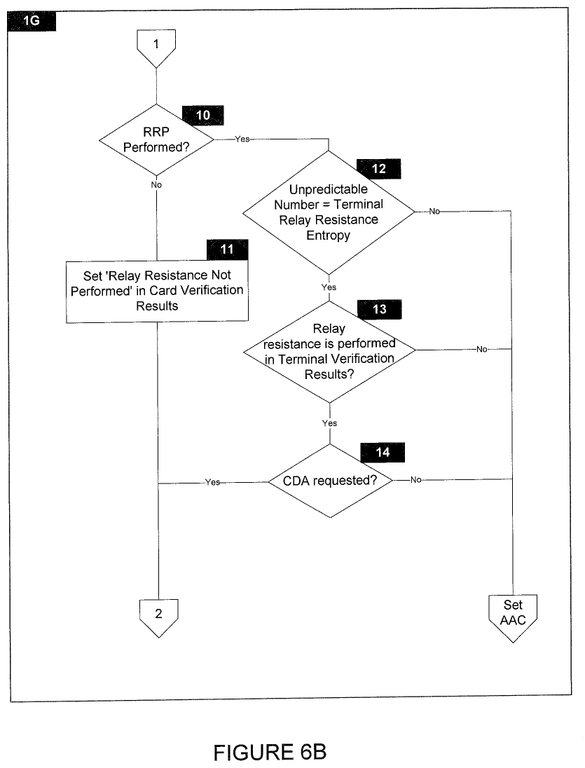

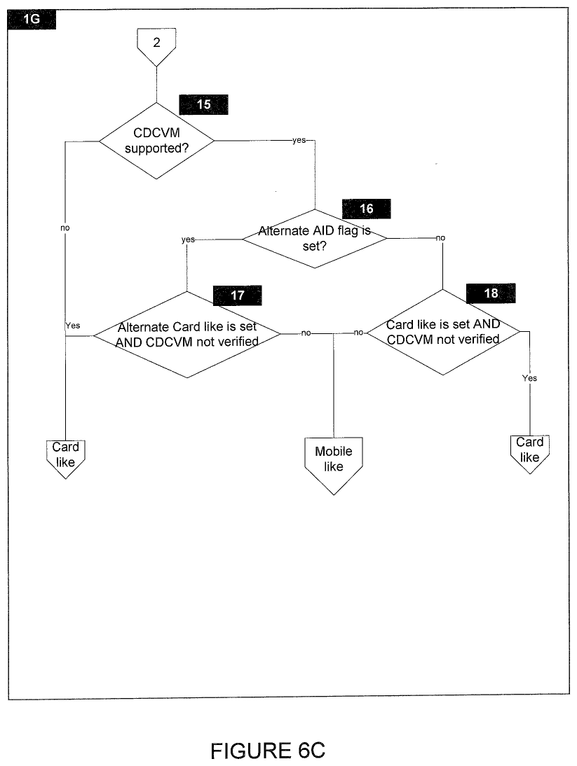

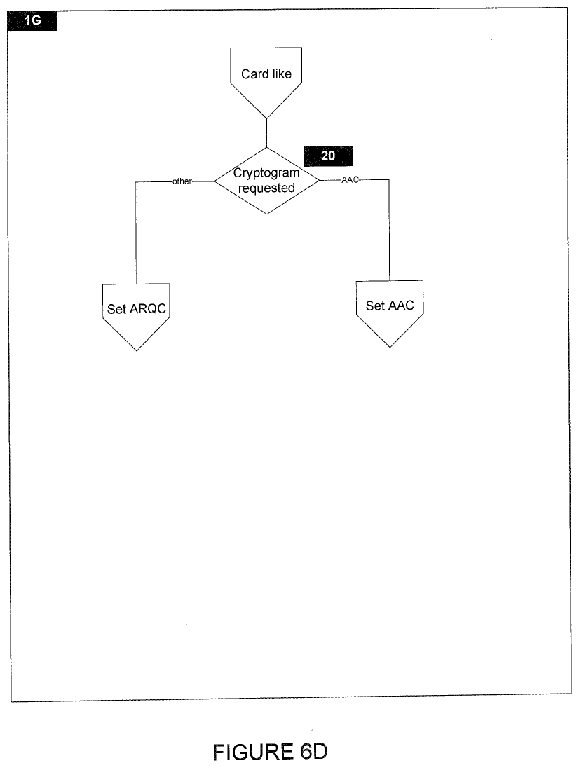

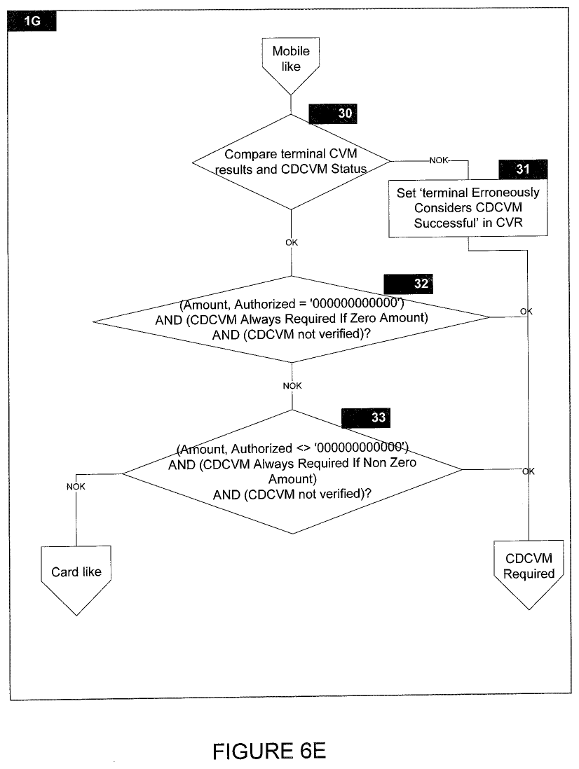

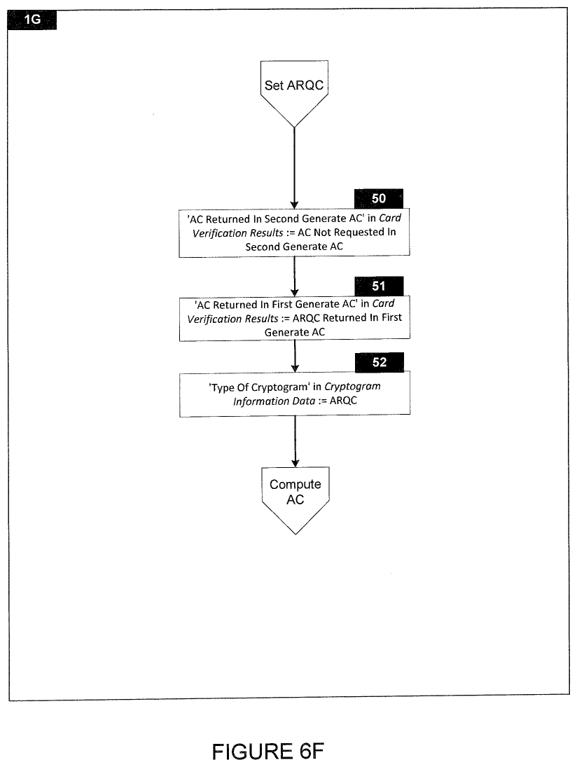

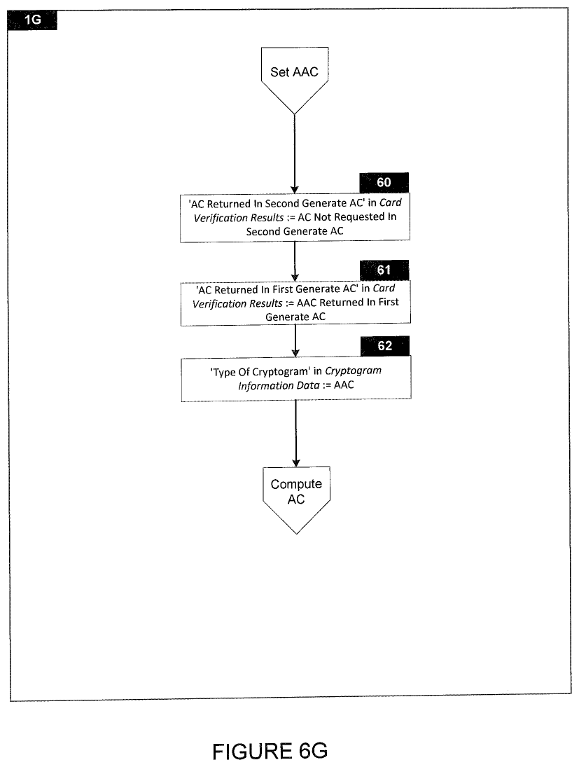

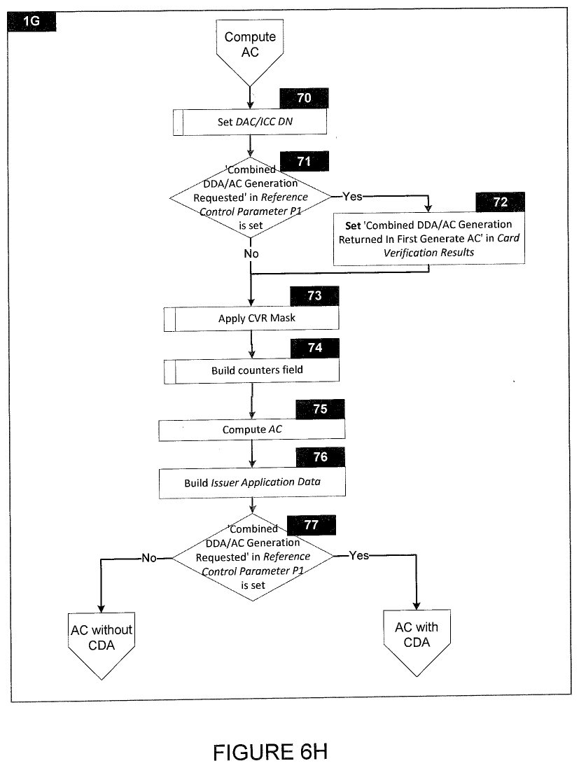

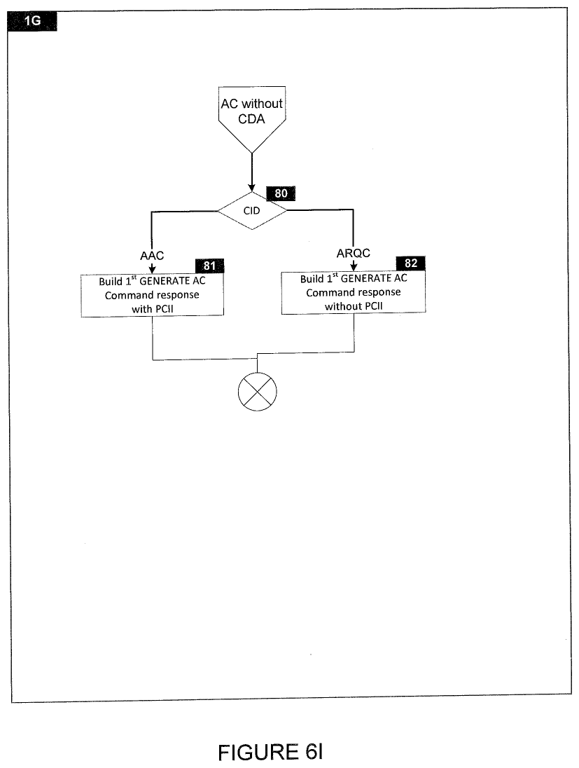

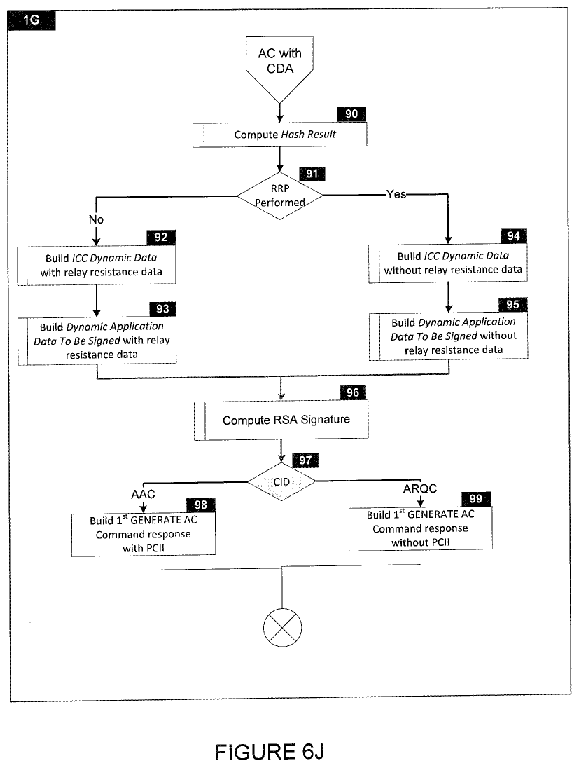

Under this command, the wearables application generates an application cryptogram used to initiate payment in EMV Mode. This is a conventional EMV command, but is modified somewhat in this implementation, in particular to support the CVM options described here. The start of GENERATE AC processing is shown in FIGS. 6A to 6C (where not explicitly described, elements of these figures can be assumed to correspond to existing EMV kernel features). After obtaining transaction related data and deriving an AC session key, it is determined whether CDCVM is supported and an appropriate flag set. It is then determined whether relay resistance and CDA (combined DDA and AC generation) are required—these are existing EMV kernel features—and the card processing type determined, as is shown in FIG. 6C. According to the CDCVM status, “card like” or “mobile like” versions of the EMV Mode may be used. In mobile like mode, the CDCVM is the only type of CVM supported if the terminal side also supports mobile. In card like mode, a verification CDCVM check is made and alternative CVMs may be supported if CDCVM is not verified and a CVM is required, though it will transact as a mobile otherwise. This approach may be useful where the CDCVM is provided remotely from the wearable device, but is not currently available—using this approach, it will be possible to fall back to another CVM method under these circumstances if needed.

Card like processing simply implements existing EMV kernel options for card processing, as shown in FIG. 6D, with generation of whichever cryptogram is required at that point. In mobile like processing, as shown in FIG. 6E, the next stage is to determine whether CDCVM is required (for example, because the transaction is above a particular amount)—if CDCVM is not needed, the cryptogram is simply produced as for card like mode. If CDCVM is required, then the card verification results are updated accordingly (see FIG. 6E).

Generation of application cryptograms then takes place essentially according to existing EMV protocols—these are shown for completeness for each cryptogram type in FIGS. 6F to 6J. FIGS. 6F and 6G indicate the different processing for an Authorization Request Cryptogram (ARQC) and an Application Authentication Cryptogram (AAC) respectively, FIG. 6H showing the main flow for Application Cryptogram generation, with FIGS. 61 and 6J showing the differences with and without CDA. As these are essentially in line with existing EMV kernels, they will not be described further in this document.

### Compute Cryptographic Checksum

Under this command, the wearables application operates in Contactless Mag-Stripe Mode and generates a checksum as a card validation code (CVC3), in which the Unpredictable Number is used as a parameter to compensate for the static nature of mag stripe data. As will be shown, POS Cardholder Interaction Information (PCII) may be included to provide additional information to the user.

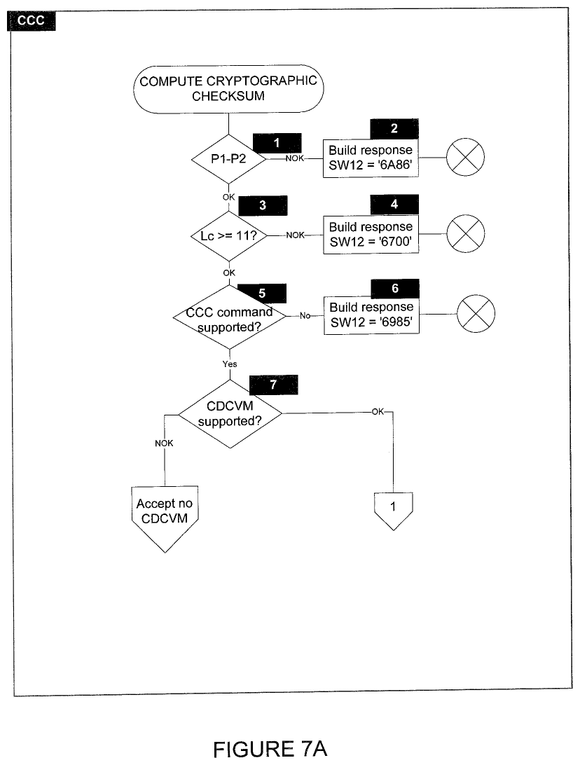

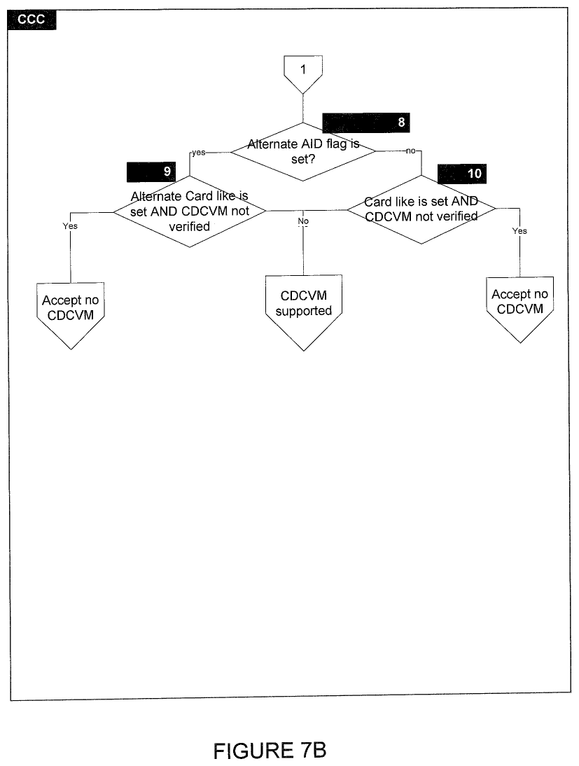

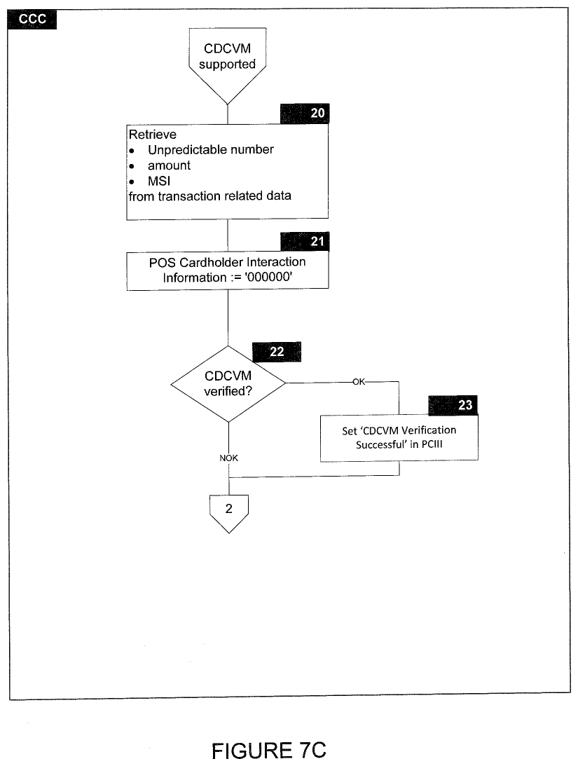

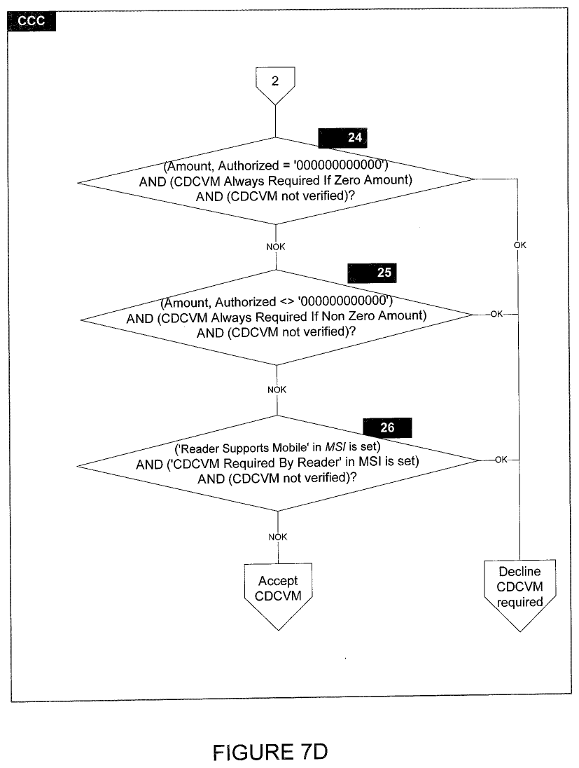

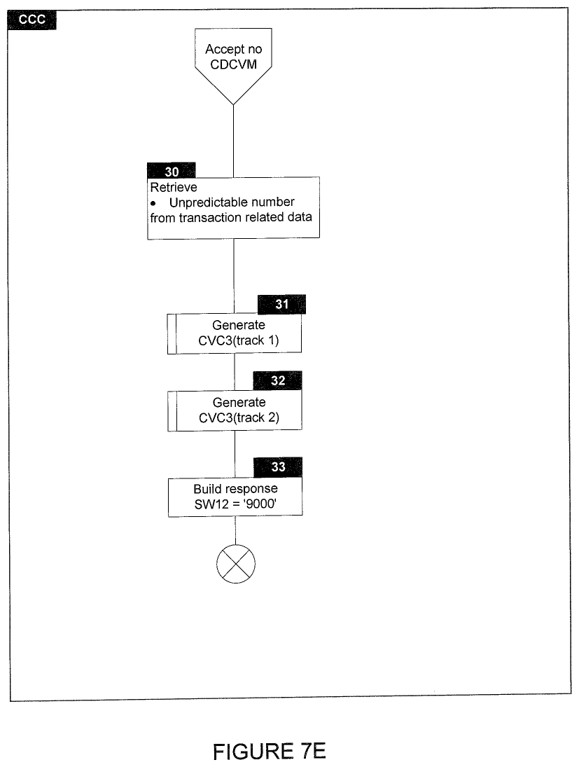

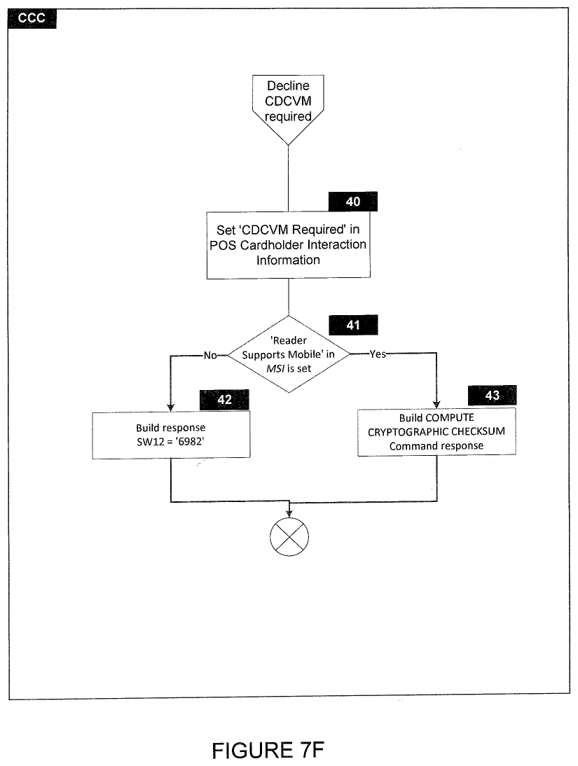

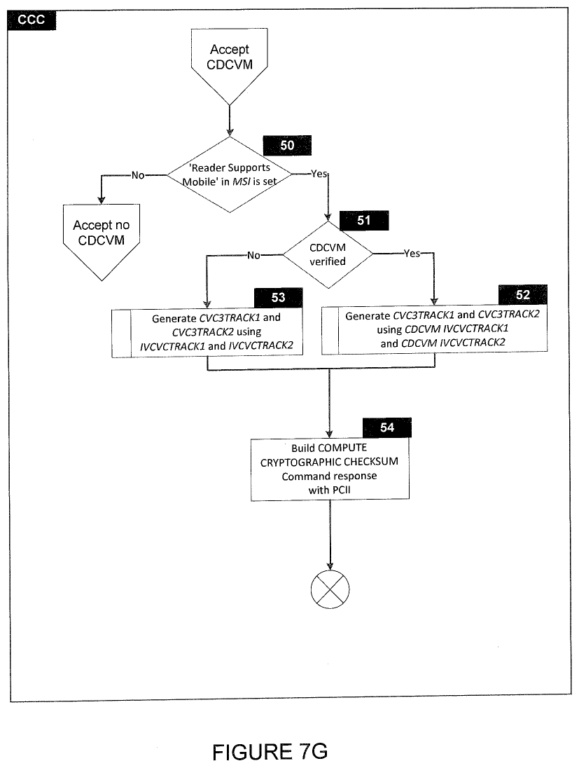

FIG. 7A shows the start of this process, which is conventional up until the step of determining whether CDCVM is supported. If not, then “Accept no CDCVM” processing is followed, with options otherwise following a similar approach to that used with GENERATE AC—however as shown in FIG. 7B, this amounts to a determination of whether “Accept no CDCVM” or “CDCVM supported” processing is followed.

CDCVM supported processing is shown in FIGS. 7C and 7D. Unpredictable Number and other required information is retrieved, and CDCVM is verified and an appropriate flag set in PCII. It is then determined whether the nature of the transaction allows the CDCVM route to be followed in which case processing proceeds with Accept CDCVM processing as shown in FIG. 7G, or if Decline CDCVM processing is required as shown in FIG. 7F. If Accept CDCVM processing is followed, CVC3 data may be built differently depending on whether or not the mobile is supported (if not, then the Accept no CDCVM processing option is followed as shown in FIG. 7E) as shown in the figures, but in accordance with existing EMV kernels and using Unpredictable Number and Application Transaction Counter as inputs.

As the person skilled in the art will appreciate, the approach described here may be varied without departing from the spirit and scope of the disclosure. In particular, embodiments may be provided that are based on other EMV kernels than that referenced here.

TABLE 3
Abbreviations Used in Document

| | |
|---|---|
| AAC | Application Authentication Cryptogram |
| AC | Application Cryptogram |
| ADF | Application Definition File |
| AFL | Application File Locator |
| AID | Application Identifier |
| AIP | Application Interchange Profile |
| an | Alphanumeric characters |
| ans | Alphanumeric and Special characters |
| APDU | Application Protocol Data Unit |
| ARQC | Authorization Request Cryptogram |
| ATC | Application Transaction Counter |
| b | Binary |
| BER | Basic Encoding Rules |
| C-APDU | Command APDU |
| CDA | Combined DDA/AC Generation |
| CDOL | Card Risk Management Data Object List |
| CDCVM | Consumer Device Cardholder Verification Method |
| CID | Cryptogram Information Data |
| CLA | Class byte of command message |
| cn | Compressed Numeric |
| CRT | Chinese Remainder Theorem |
| CSK | Common Session Key |
| CVC | Card Verification Code |
| CVM | Cardholder Verification Method |
| CVR | Card Verification Results |
| DAC | Data Authentication Code |
| DES | Data Encryption Standard |
| EMV | Europay Mastercard Visa |
| FCI | File Control Information |
| ICC | Integrated Circuit Card |
| IDN | ICC Dynamic Number |
| INS | Instruction byte of command message |
| IVCVC3 | Initialization Vector for CVC3 generation |
| KDCVC3 | ICC Derived Key for CVC3 generation |
| MAC | Message Authentication Code |
| MKAC | AC Master Key |
| MKIDN | ICC Dynamic Number Master Key |
| MSI | Mobile Support Indicator |
| n | Numeric |
| N_{IC} | Length of the ICC Public Key Modulus |
| O | Optional |
| P | Processed |
| PAN | Primary Account Number |
| PCII | POS Cardholder Interaction Information |
| PDOL | Processing Options Data Object List |
| PPSE | Proximity Payment System Environment |
| R/CNS | Rejected, Conditions Not Satisfied |
| RFU | Reserved for Future Use |
| R-APDU | Response APDU |
| SFI | Short File Identifier |
| SHA | Secure Hash Algorithm |
| SK | Session Key (or private key in RSA context) |
| SKD | Session Key Derivation |
| SW12 | Status bytes 1-2 |
| TLV | Tag Length Value |
| TVR | Terminal Verification Results |
| var. | Variable |

1. A method of operating a transaction device to perform a contactless transaction with a terminal of a transaction system, the method comprising: determining if the transaction device has associated with it a mechanism for providing user verification at the transaction device, and if there is an associated user verification mechanism, transacting with the terminal according to a first transaction protocol, and if there is no associated user verification mechanism, transacting with the terminal according to a second transaction protocol.

2. The method of claim 1, wherein the user verification mechanism is provided within the transaction device.

3. The method of claim 1, wherein the user verification mechanism is provided at a second device in wireless communication with the transaction device.

4. The method of claim 3, wherein the second device is a mobile telephone handset.

5. The method of claim 1, wherein the user verification mechanism is a biometric mechanism.

6. The method of claim 5, wherein the biometric mechanism is a fingerprint reader.

7. The method of claim 1, wherein the contactless transaction is performed under EMV contactless protocols.

8. The method of claim 7, wherein the user verification mechanism is a Consumer Device Customer Verification Method.

9. The method of claim 8, wherein the transaction device uses a transaction protocol suitable for a mobile telephone payment device when a Consumer Device Customer Verification Method is present.

10. The method of claim 8, wherein the transaction device uses a transaction protocol suitable for a contactless payment card when a Consumer Device Customer Verification Method is not present.

11. The method of claim 1, wherein the transaction device is a wearable payment device.

12. The method of claim 11, wherein the transaction device comprises one of a ring, a band, a strap or a pendant.

13. A transaction device comprising a memory and a processor, and adapted to perform a contactless transaction with a terminal of a transaction system, wherein the transaction device is adapted to determine if the transaction device has associated with it a mechanism for providing user verification at the transaction device, and if there is an associated user verification mechanism, transacting with the terminal according to a first transaction protocol, and if there is no associated user verification mechanism, transacting with the terminal according to a second transaction protocol.

14. The transaction device of claim 13, wherein the user verification mechanism is provided within the transaction device.

15. The transaction device of claim 13, wherein the user verification mechanism is provided at a second device in wireless communication with the transaction device.

16. The transaction device of claim 13, wherein the user verification mechanism is a biometric mechanism.

17. The transaction device of claim 16, wherein the biometric mechanism is a fingerprint reader.

18. The transaction device of claim 13, wherein the contactless transaction is performed under EMV contactless protocols.

19. The transaction device of claim 13, wherein the transaction device is a wearable payment device.

20. The transaction device of claim 19, wherein the transaction device comprises one of a ring, a band, a strap or a pendant.

21. A program product which when installed on a transaction device, enables the transaction device to: determine if the transaction device has associated with it a mechanism for providing user verification at the transaction device, and if there is an associated user verification mechanism, transact with the terminal according to a first transaction protocol; and if there is no associated user verification mechanism, transact with the terminal according to a second transaction protocol.
